(19) United States
(12) Patent Application Publication
(10) Pub. No.: US 2023/0416155 A1
(43) Pub. Date: Dec. 28, 2023

(54) FREQUENCY-STABLE LOW-DIELECTRIC MICROWAVE DIELECTRIC CERAMIC MATERIAL AND PREPARATION METHOD THEREOF

(71) Applicant: JIAXING GLEAD ELECTRONICS CO., LTD, Zhejiang (CN)

(72) Inventors: Shunguo LIU, Zhejiang (CN); Jianxi TONG, Zhejiang (CN); Qiang LIU, Zhejiang (CN); Dan HUANG, Zhejiang (CN); Jinhua XU, Zhejiang (CN); Xuebin SHI, Zhejiang (CN)

(73) Assignee: JIAXING GLEAD ELECTRONICS CO., LTD, Zhejiang (CN)

(21) Appl. No.: 17/779,133

(22) PCT Filed: Mar. 31, 2021
(86) PCT No.: PCT/CN2021/084472

§ 371 Date: May 24, 2022

(30) Foreign Application Priority Data
Mar. 10, 2021 (CN) 202110260060.7

(51) Int. Cl. C04B 35/20; C04B 35/626; C04B 35/634; C04B 35/64; H01B 3/12

(52) U.S. Cl. CPC C04B 35/20; C04B 2235/6567; C04B 35/6262; C04B 35/62675; C04B 35/62655; C04B 35/62695; C04B 35/63416; C04B 35/64; H01B 3/12; C04B 2235/3445; C04B 2235/3206; C04B 2235/3418; C04B 2235/3275; C04B 2235/442; C04B 2235/3227; C04B 2235/3217; C04B 2235/3236; C04B 2235/3229; C04B 2235/3267; C04B 2235/3284; C04B 2235/606; C04B 2235/604; C04B 35/6264

(57) ABSTRACT

The present invention relates to a frequency-stable low-dielectric microwave dielectric ceramic material and a preparation method thereof. The material is prepared from the following components in percentage by mass: 70-90% of a main-phase ceramic material A, 10-30% of an auxiliary-phase ceramic material B and 0-1.0% of an oxide sintering aid C. The main-phase ceramic material A is MgₓMe_{y}SiO_{2+x+y}; the auxiliary-phase ceramic material B is composed of αRO-bRe₂O₃-cTiO₂, R is at least one of Ca or Sr, Re₂O₃ is at least two of Sm₂O₃, Nd₂O₃, Y₂O₃, Al₂O₃ and La₂O₃; and the oxide sintering aid C is at least one of MnO₂, WO₃ and CeO₂.

### BACKGROUND

### Technical Field

The disclosure belongs to the technical field of material science, and in particular relates to a frequency-stable low-dielectric microwave dielectric ceramic material and a preparation method thereof.

### Description of Related Art

Microwave dielectric ceramics are functional ceramic materials used in microwave frequency circuits to achieve one or more functions. They play an important role in the application of modern communication technology. They are material used to prepare crucial devices such as dielectric resonators, dielectric filters and dielectric waveguide filters. As the new generation of mobile communication and high-frequency network communication have higher requirements for low latency and reliability of signal transmission, microwave dielectric ceramic materials with low dielectric constant and excellent temperature coefficient stability have received more attention. Typical applications, such as filters in 5G base stations, usually require the frequency temperature coefficient of −40° C. to 110° C. to be within ±5 ppm/° C., so as to ensure that the device has high frequency stability in environments with large temperature differences.

Mg₂SiO₄ is a frequency-stable low-dielectric microwave dielectric ceramic material with excellent performance. Its εᵣ=6.8, Q×f=270,000 GHz, but its τ_{f} is −70 ppm/° C., usually positive τ_{f} materials such as CaTiO₃ is doped or introduced to adjust τ_{f} to nearly 0 so as to be applied in the preparation of microwave devices. Patent No. CN101863655 discloses Mg₂SiO₄ and MgCaSiO₄ ceramics prepared by replacing Mg with Ca, τ_{f} is close to 0 and can be adjusted, but the value of Q×f is too low and is only about 20000 GHz. On the other hand, Mg₂SiO₄ ceramics further have a high coefficient of thermal expansion (˜10 ppm/° C. approximately), which can reduce the risk of cracking of devices in temperature-changing environments and improve product reliability, while cordierite ceramics, which is also a low-dielectric material, only has the thermal expansion coefficient of about 2 ppm/° C.

Ling Liu et al. replaced Ca_{0.9}Sr_{0.1}TiO₃ of Ca²⁺ by Sr²⁺ in the publication of “Microstructures and microwave dielectric properties of Mg₂SiO₄-Ca_{0.9}Sr_{0.1}TiO₃ ceramics” published in “Journal of Materials Science: Materials in Electronics”, Vol. 26, pp. 1316-1321, 2014, in which τ_{f} of Mg₂SiO₄ is adjusted to −3.62 ppm/° C., while obtaining higher Q×f value. However, in practical applications, due to the poor linearity of the temperature coefficient of the simple perovskite structures of CaTiO₃, SrTiO₃ or Ca₁₋ₓSrₓTiO₃, it is difficult for the corresponding products to satisfy the frequency temperature coefficient requirement of τ_{f}≤5 ppm/° C. in the full temperature range (such as −40° C. to 110° C.) simultaneously. The frequency stability of related devices is poor, which limits its use in mobile base stations.

On the other hand, due to the great difference in the diffusion rate of Si⁴⁺ of Mg²⁺ during the sintering process, it is very likely to form the second phase MgSiO₃ or incompletely reacted SiO₂. Since the loss of MgSiO₃ is much larger than that of Mg₂SiO₄ phase, this dramatically deteriorates the dielectric properties of Mg₂SiO₄ ceramics. Excessive SiO₂ is likely to form a liquid phase during the sintering process, resulting in abnormal growth of grains, which will also deteriorate the dielectric properties and mechanical strength of the material. Patent No. CN101429015 discloses a method for adjusting the ratio of Mg/Si to eliminate the second phase, but the sintering temperature is relatively high and τ_{f} is not adjusted to nearly 0, so the material application is more likely to be limited.

### SUMMARY

### The Technical Problems to be Solved

In order to solve the above technical problems, the first purpose of the present disclosure is to provide a frequency-stable low-dielectric microwave dielectric ceramic material, which has a high Q×f value and a small frequency temperature coefficient in a broad temperature range. The second purpose of the present disclosure is to provide a preparation method of a frequency-stable low-dielectric microwave dielectric ceramic material, which has a simple sintering process and good repeatability.

### The Technical Solutions

In order to realize the purpose of the above-mentioned first disclosure, the present disclosure adopts the following technical solutions.

A frequency-stable low-dielectric microwave dielectric ceramic material is prepared from the following components in percentage by mass: 70 to 90% of a main-phase ceramic material A, 10 to 30% of an auxiliary-phase ceramic material B and 0 to 1.0% of an oxide sintering aid C, and the sum of mass percentage of the main-phase ceramic material A, the auxiliary-phase ceramic material B and the oxide sintering aid C is 100%. The main-phase ceramic material A satisfies chemical formula MgₓMe_{y}SiO_{2+x+y}, and Me is Co or Zn. The auxiliary-phase ceramic material B is composed of αRO-bRe₂O₃-cTiO₂, R is at least one of Ca or Sr, and Re₂O₃ is at least two of Sm₂O₃, Nd₂O₃, Y₂O₃, Al₂O₃ and La₂O₃; and the oxide sintering aid C is at least one of MnO₂, MnCO₃, WO₃, and CeO₂.

In a preferred solution: 2.00≤x+y≤2.20, 1.80≤x≤2.15, 0≤y≤0.40.

In a preferred solution: 1.0≤a≤2.0, 0.05≤b≤0.50, 1.0≤c≤1.5.

In a further preferred solution: 2.00≤x+y≤2.10, 1.80≤x≤2.05, 0.05≤y≤0.25.

In a further preferred solution: 1.0≤a≤1.5, 0.05≤b≤0.30, 1.0≤c≤1.2.

In a preferred solution: Re₂O₃ in the chemical formula of the auxiliary-phase ceramic material B is Al₂O₃ and Sm₂O₃, or Al₂O₃ and Nd₂O₃, or Al₂O₃ and Y₂O₃, or Al₂O₃ and La₂O₃.

In order to realize the purpose of the above-mentioned second disclosure, the present disclosure adopts the following technical solutions.

A preparation method for preparing the frequency-stable low-dielectric microwave dielectric ceramic as described above, including the following steps.

1) Synthesis of Main-Phase Ceramic Material A:

The raw materials MgO, SiO₂, ZnO, and CoO are weighed and mixed according to the ratio of chemical formula MgₓMe_{y}SiO_{2+x+y}, deionized water is used as the solvent, and the mixture is ball-milled for 16 to 24 hours and then dried. The dried mixture is filtered through a 40-mesh sieve, put into an alumina crucible, calcined at 1150° C. to 1300° C. for 2 to 4 hours to synthesize the main-phase powder A, the main-phase powder A is ground and filtered through a 40-mesh sieve for use.

2) Synthesis of Auxiliary-Phase Ceramic Material B:

According to the chemical formula αRO-bRe₂O₃-cTiO₂, the raw materials CaCO₃, SrCO₃, Sm₂O₃, Nd₂O₃, Y₂O₃, Al₂O₃ and La₂O₃ are weighed and mixed, and deionized water is used as the solvent, the mixture is ball-milled for 16 to 24 hours, and then dried, and then filtered through a 40-mesh sieve, loaded into an alumina crucible, calcined at 1100° C. to 1300° C. for 2 to 4 hours to synthesize an auxiliary-phase powder B, which is ground and filtered through a 40-mesh sieve for use.

3) The main-phase ceramic material A, auxiliary-phase ceramic material B and oxide sintering aid C are prepared according to a certain ratio, ZrO₂ balls are used as the grinding medium, and deionized water is added according to the weight ratio of the mixture to deionized water 1:1.5 to 2. Wet mixing is adopted to mix the material for 12 to 18 hours. The material is dried at 120° C., added with 1% to 3% of polyvinyl alcohol binder by weight for grinding and granulating, and filtered through a 40-mesh sieve. Under the pressure of 80 to 120 MPa, the material is pressed into a green body with a diameter of 20 mm and a thickness of 10 mm, and sintered at 1300° C. to 1450° C. for 2 to 4 hours in an air atmosphere to obtain the frequency-stable low-dielectric microwave dielectric ceramic material.

### The Advantageous Effects

Compared with the conventional technology, the present disclosure has the following advantages. 1. By improving the simple perovskite structures CaTiO₃ and SrTiO₃, and adjusting the ratio of each component of the ceramic, the frequency temperature coefficient of the ceramic material in the full temperature range is optimized, so as to ensure that the device is in an environment with a large temperature difference has a high frequency stability.

2. The present disclosure eliminates the problem of the second phase MgSiO₃ and SiO₂ phase residues through the non-stoichiometric design of Mg₂SiO₄ and the substitution of A-site Mg²⁺, suppresses the abnormal growth of crystal grains, and has a broad sintering temperature range. The introduction of oxide sintering aid further reduces the sintering temperature of the material. The disclosure has simple preparation process, good process operability and reproducibility, as well as good microwave dielectric performance, and may be used for the preparation of devices such as dielectric filters and dielectric duplexers in new-generation mobile communications and high-frequency network communications.

### BRIEF DESCRIPTION OF THE DRAWINGS

The accompanying drawings that constitute a part of the present disclosure are used to provide further understanding of the present disclosure, and the schematic embodiments and descriptions of the present disclosure are used to explain the present disclosure and do not constitute a limitation to the present disclosure.

In FIG. 1, (a) is Comparative Example 1, (b) is Comparative Example 2, (c) is Embodiment 3, and (d) is a scanning electron microscope image of the microwave dielectric ceramic material prepared in Embodiment 6.

FIG. 2 is a comparison diagram of the frequency temperature coefficient of Comparative Examples 1, 2 and Embodiments 5 and 8 at different temperatures.

### DESCRIPTION OF THE EMBODIMENTS

The present disclosure will be described below in conjunction with specific embodiments.

### Embodiment 1

1) Synthesis of main-phase ceramic material A: The raw materials MgO, SiO₂, and CoO are weighed and mixed according to the ratio of chemical formula Mg_{2.00}Co_{0.10}SiO_{4.10}. Deionized water is added according to the ratio of mixture to deionized water 1:3, the material is mixed and ground for 20 hours, then dried in an oven at 120° C., ground with a quartz mortar and filtered through a 40-mesh sieve, and then the powder is put into an alumina crucible and calcined at 1250° C. for 3 hours to obtain the main-phase pre-calcined powder A.

2) Synthesis of auxiliary-phase ceramic material B: The raw materials CaCO₃, SrCO₃, La₂O₃, Al₂O₃ and TiO₂ are weighed and mixed according to the chemical composition of 0.99CaO·0.11SrO-0.06La₂O₃·0.05Al₂O₃-1.00TiO₂. Deionized water is added according to the ratio of the mixture to deionized water 1:2, the material is mixed and ground for 16 hours and dried in an oven at 120° C., ground with a quartz mortar and filtered through a 40-mesh sieve, and then the powder is put into an alumina crucible and calcined at 1200° C. for 3 hours to obtain auxiliary-phase pre-calcined powder B.

3) 82.3 wt % of the main-phase ceramic material A and 16.7 wt % of the auxiliary-phase ceramic material B are mixed, and 0.25 wt % of CeO₂ and 0.75% of MnO₂ are mixed. ZrO₂ balls are used as the grinding medium. Deionized water is added according to the weight ratio of mixture: zirconia balls: deionized water 1:5:1.8. After 15 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1300° C. for 3 hours to obtain a frequency-stable low-dielectric ceramic material and its dielectric properties are tested.

### Embodiment 2

1) Synthesis of main-phase ceramic material A: The raw materials MgO, SiO₂ and ZnO are weighed according to the ratio of chemical formula Mg_{2.02}Zn_{0.05}SiO_{4.07}. Deionized water is added according to the ratio of mixture to deionized water 1:3, the material is mixed and ground for 16 hours, dried in a 120° C. oven, ground by using a quartz mortar, and filtered through a 40-mesh sieve. Then the powder is put into an alumina crucible for calcination at 1200° C. for 3 hours to obtain the main-phase pre-calcined powder A.

2) Synthesis of auxiliary-phase ceramic material B: The raw materials CaCO₃, SrCO₃, Nd₂O₃, Al₂O₃ and TiO₂ are weighed and mixed according to the chemical composition 1.05CaO·0.12SrO-0.08Nd₂O₃·0.06Al₂O₃-1.05TiO₂. Deionized water is added according to the ratio of mixture to deionized water 1:2, the material is mixed and ground for 20 hours, and dried in an oven at 120° C., ground with a quartz mortar and filtered through a 40-mesh sieve. Then the powder is put into an alumina crucible and calcined at 1200° C. for 3 hours to obtain auxiliary-phase pre-calcined powder B.

3) 81.8 wt % of the main-phase ceramic material A and 17.7 wt % of the auxiliary-phase ceramic material B are mixed, and 0.2 wt % of WO₃ and 0.3 wt % of MnO₂ are mixed. ZrO₂ balls are used as the grinding medium. Deionized water is added according to the weight ratio of mixture: zirconia balls: deionized water 1:5:1.8. After 12 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1350° C. for 3 hours to obtain a frequency-stable low-dielectric ceramic material and its dielectric properties are tested.

### Embodiment 3

1) Synthesis of main-phase ceramic material A: The raw materials MgO, SiO₂, and CoO are weighed and mixed according to the ratio of chemical formula Mg_{1.95}Co_{0.10}SiO_{4.05}. Deionized water is added according to the ratio of mixture to deionized water 1:3, the material is mixed and ground for 20 hours, then dried in an oven at 120° C., ground with a quartz mortar and filtered through a 40-mesh sieve, and then the powder is put into an alumina crucible and calcined at 1150° C. for 4 hours to obtain the main-phase pre-calcined powder A.

2) Synthesis of auxiliary-phase ceramic material B: The raw materials CaCO₃, SrCO₃, La₂O₃, Al₂O₃ and TiO₂ are weighed and mixed according to the chemical composition of 1.25CaO·0.20SrO-0.15La₂O₃·0.12Al₂O₃-1.20TiO₂. Deionized water is added according to the ratio of the mixture to deionized water 1:2, the material is mixed and ground for 16 hours and dried in an oven at 120° C., ground with a quartz mortar and filtered through a 40-mesh sieve, and then the powder is put into an alumina crucible and calcined at 1250° C. for 2 hours to obtain auxiliary-phase pre-calcined powder B.

3) 79.5 wt % of the main-phase ceramic material A and 20.1 wt % of the auxiliary-phase ceramic material B are mixed, and 0.3 wt % of CeO₂ and 0.1% of WO₃ are mixed. ZrO₂ balls are used as the grinding medium. Deionized water is added according to the weight ratio of mixture: zirconia balls: deionized water 1:5:1.8. After 15 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1300° C. for 3 hours to obtain a frequency-stable low-dielectric ceramic material and its dielectric properties are tested.

### Embodiment 4

1) Synthesis of main-phase ceramic material A: The raw materials MgO, SiO₂, and CoO are weighed and mixed according to the ratio of chemical formula Mg_{2.00}Co_{0.05}SiO_{4.05}. Deionized water is added according to the ratio of mixture to deionized water 1:3, the material is mixed and ground for 20 hours, then dried in an oven at 120° C., ground with a quartz mortar and filtered through a 40-mesh sieve, and then the powder is put into an alumina crucible and calcined at 1200° C. for 3 hours to obtain the main-phase pre-calcined powder A.

2) Synthesis of auxiliary-phase ceramic material B: The raw materials CaCO₃, SrCO₃, Sm₂O₃, Al₂O₃ and TiO₂ are weighed and mixed according to the chemical composition of 0.85CaO·0.45SrO-0.15Sm₂O₃·0.10Al₂O₃-1.10TiO₂. Deionized water is added according to the ratio of the mixture to deionized water 1:2, the material is mixed and ground for 20 hours and dried in an oven at 120° C., ground with a quartz mortar and filtered through a 40-mesh sieve, and then the powder is put into an alumina crucible and calcined at 1150° C. for 4 hours to obtain auxiliary-phase pre-calcined powder B.

3) 84.6 wt % of the main-phase ceramic material A, 14.9 wt % of the auxiliary-phase ceramic material B and 0.5 wt % of MnO₂ are mixed. ZrO₂ balls are used as the grinding medium. Deionized water is added according to the weight ratio of mixture: zirconia balls: deionized water 1:5:1.8. After 18 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1400° C. for 2 hours to obtain a frequency-stable low-dielectric ceramic material and its dielectric properties are tested.

### Embodiment 5

1) Synthesis of main-phase ceramic material A: The raw materials MgO, SiO₂, and ZnO are weighed and mixed according to the ratio of chemical formula Mg_{1.90}Zn_{0.20}SiO_{4.10}. Deionized water is added according to the ratio of mixture to deionized water 1:3, the material is mixed and ground for 16 hours, then dried in an oven at 120° C., ground with a quartz mortar and filtered through a 40-mesh sieve, and then the powder is put into an alumina crucible and calcined at 1150° C. for 2 hours to obtain the main-phase pre-calcined powder A.

2) Synthesis of auxiliary-phase ceramic material B: The raw materials CaCO₃, SrCO₃, Nd₂O₃, Al₂O₃ and TiO₂ are weighed and mixed according to the chemical composition of 0.95CaO·0.15SrO-0.10Y₂O₃·0.08Al₂O₃-1.05TiO₂. Deionized water is added according to the ratio of the mixture to deionized water 1:2, the material is mixed and ground for 24 hours and dried in an oven at 120° C., ground with a quartz mortar and filtered through a 40-mesh sieve, and then the powder is put into an alumina crucible and calcined at 1100° C. for 3 hours to obtain auxiliary-phase pre-calcined powder B.

3) 80.6 wt % of the main-phase ceramic material A, 18.4 wt % of the auxiliary-phase ceramic material B, 0.5 wt % of CeO₂, and 0.5 wt % of MnO₂ are mixed. ZrO₂ balls are used as the grinding medium. Deionized water is added according to the weight ratio of mixture: zirconia balls: deionized water 1:5:1.8. After 12 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1300° C. for 4 hours to obtain a frequency-stable low-dielectric ceramic material and its dielectric properties are tested.

### Embodiment 6

1) Synthesis of main-phase ceramic material A: The raw materials MgO, SiO₂, and ZnO are weighed and mixed according to the ratio of chemical formula Mg_{2.00}Zn_{0.03}SiO_{4.10}. Deionized water is added according to the ratio of mixture to deionized water 1:3, the material is mixed and ground for 16 hours, then dried in an oven at 120° C., ground with a quartz mortar and filtered through a 40-mesh sieve, and then the powder is put into an alumina crucible and calcined at 1200° C. for 3 hours to obtain the main-phase pre-calcined powder A.

2) Synthesis of auxiliary-phase ceramic material B: The raw materials CaCO₃, SrCO₃, Nd₂O₃, Al₂O₃ and TiO₂ are weighed and mixed according to the chemical composition of 1.10CaO·0.20SrO-0.18Nd₂O₃·0.12Al₂O₃-1.20TiO₂. Deionized water is added according to the ratio of the mixture to deionized water 1:2, the material is mixed and ground for 20 hours and dried in an oven at 120° C., ground with a quartz mortar and filtered through a 40-mesh sieve, and then the powder is put into an alumina crucible and calcined at 1250° C. for 2 hours to obtain auxiliary-phase pre-calcined powder B.

3) 79.5 wt % of the main-phase ceramic material A, 19.9 wt % of the auxiliary-phase ceramic material B, 0.1 wt % of WO₃, and 0.5 wt % of MnO₂ are mixed. ZrO₂ balls are used as the grinding medium. Deionized water is added according to the weight ratio of mixture: zirconia balls: deionized water 1:5:1.8. After 18 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1350° C. for 3 hours to obtain a frequency-stable low-dielectric ceramic material and its dielectric properties are tested.

### Embodiment 7

1) Synthesis of main-phase ceramic material A: The raw materials MgO, SiO₂, and CoO are weighed and mixed according to the ratio of chemical formula Mg_{1.85}Co_{0.25}SiO_{4.10}. Deionized water is added according to the ratio of mixture to deionized water 1:3, the material is mixed and ground for 20 hours, then dried in an oven at 120° C., ground with a quartz mortar and filtered through a 40-mesh sieve, and then the powder is put into an alumina crucible and calcined at 1250° C. for 2 hours to obtain the main-phase pre-calcined powder A.

2) Synthesis of auxiliary-phase ceramic material B: The raw materials CaCO₃, SrCO₃, La₂O₃, Al₂O₃ and TiO₂ are weighed and mixed according to the chemical composition of 1.20CaO·0.25SrO₃-0.20La₂O₃·0.10Al₂O₃-1.18TiO₂. Deionized water is added according to the ratio of the mixture to deionized water 1:2, the material is mixed and ground for 16 hours and dried in an oven at 120° C., ground with a quartz mortar and filtered through a 40-mesh sieve, and then the powder is put into an alumina crucible and calcined at 1300° C. for 4 hours to obtain auxiliary-phase pre-calcined powder B.

3) 76.8 wt % of the main-phase ceramic material A, 22.9 wt % of the auxiliary-phase ceramic material B, and 0.3 wt % of CeO₂ are mixed. ZrO₂ balls are used as the grinding medium. Deionized water is added according to the weight ratio of mixture: zirconia balls: deionized water 1:5:1.8. After 15 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1400° C. for 3 hours to obtain a frequency-stable low-dielectric ceramic material and its dielectric properties are tested.

### Embodiment 8

1) Synthesis of main-phase ceramic material A: The raw materials MgO, SiO₂, and ZnO are weighed and mixed according to the ratio of chemical formula Mg_{2.02}Zn_{0.05}SiO_{4.07}. Deionized water is added according to the ratio of mixture to deionized water 1:3, the material is mixed and ground for 16 hours, then dried in an oven at 120° C., ground with a quartz mortar and filtered through a 40-mesh sieve, and then the powder is put into an alumina crucible and calcined at 1200° C. for 3 hours to obtain the main-phase pre-calcined powder A.

2) Synthesis of auxiliary-phase ceramic material B: The raw materials CaCO₃, SrCO₃, Sm₂O₃, Al₂O₃ and TiO₂ are weighed and mixed according to the chemical composition of 1.15CaO·0.10SrO-0.10Sm₂O₃·0.15Al₂O₃-1.10TiO₂. Deionized water is added according to the ratio of the mixture to deionized water 1:2, the material is mixed and ground for 20 hours and dried in an oven at 120° C., ground with a quartz mortar and filtered through a 40-mesh sieve, and then the powder is put into an alumina crucible and calcined at 1200° C. for 3 hours to obtain auxiliary-phase pre-calcined powder B.

3) 79.3 wt % of the main-phase ceramic material A, 20.2 wt % of the auxiliary-phase ceramic material B, 0.2 wt % of CeO₂, and 0.3% of MnO₂ are mixed. Moreover, 0.5% of CeO₂ and 0.3% of MnO₂ by the total mass of the main-phase A and the auxiliary-phase B are added. ZrO₂ balls are used as the grinding medium. Deionized water is added according to the weight ratio of mixture: zirconia balls: deionized water 1:5:1.8. After 15 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1370° C. for 3 hours to obtain a frequency-stable low-dielectric ceramic material and its dielectric properties are tested.

### Embodiment 9

1) Synthesis of main-phase ceramic material A: The raw materials MgO, SiO₂, and CoO are weighed and mixed according to the ratio of chemical formula Mg_{1.90}Co_{0.10}SiO_{4.00}. Deionized water is added according to the ratio of mixture to deionized water 1:3, the material is mixed and ground for 20 hours, then dried in an oven at 120° C., ground with a quartz mortar and filtered through a 40-mesh sieve, and then the powder is put into an alumina crucible and calcined at 1250° C. for 2 hours to obtain the main-phase pre-calcined powder A.

2) Synthesis of auxiliary-phase ceramic material B: The raw materials CaCO₃, SrCO₃, La₂O₃, Al₂O₃ and TiO₂ are weighed and mixed according to the chemical composition of 1.25CaO·0.25SrO-0.15Y₂O₃·0.15Al₂O₃-1.08TiO₂. Deionized water is added according to the ratio of the mixture to deionized water 1:2, the material is mixed and ground for 20 hours and dried in an oven at 120° C., ground with a quartz mortar and filtered through a 40-mesh sieve, and then the powder is put into an alumina crucible and calcined at 1300° C. for 3 hours to obtain auxiliary-phase pre-calcined powder B.

3) 75.7 wt % of the main-phase ceramic material A, 24.0 wt % of the auxiliary-phase ceramic material B, and 0.3 wt % of WO₃ are mixed. ZrO₂ balls are used as the grinding medium. Deionized water is added according to the weight ratio of mixture: zirconia balls: deionized water 1:5:1.8. After 18 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1350° C. for 4 hours to obtain a frequency-stable low-dielectric ceramic material and its dielectric properties are tested.

### Comparative Example 1

1) Synthesis of main-phase ceramic material A: The raw materials MgO and SiO₂ are weighed and mixed according to the ratio of chemical formula Mg_{2.00}SiO_{4.00}. Deionized water is added according to the ratio of mixture to deionized water 1:3, the material is mixed and ground for 24 hours, then dried in an oven at 120° C., ground with a quartz mortar and filtered through a 40-mesh sieve, and then the powder is put into an alumina crucible and calcined at 1300° C. for 3 hours to obtain the main-phase pre-calcined powder A.

2) Synthesis of auxiliary-phase ceramic material B: The raw materials CaCO₃ and TiO₂ are weighed and mixed according to the chemical composition of CaTiO₃. Deionized water is added according to the ratio of the mixture to deionized water 1:2, the material is mixed and ground for 16 hours and dried in an oven at 120° C., ground with a quartz mortar and filtered through a 40-mesh sieve, and then the powder is put into an alumina crucible and calcined at 1100° C. for 3 hours to obtain auxiliary-phase pre-calcined powder B.

3) 85 wt % of the main-phase ceramic material A and 15 wt % of the auxiliary-phase ceramic material B are mixed. ZrO₂ balls are used as the grinding medium. Deionized water is added according to the weight ratio of mixture: zirconia balls: deionized water 1:5:1.8. After 18 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1420° C. for 3 hours to obtain a microwave dielectric ceramic of the Comparative Example and its dielectric properties are tested.

### Comparative Example 2

1) Synthesis of main-phase ceramic material A: The raw materials MgO and SiO₂ are weighed and mixed according to the ratio of chemical formula Mg_{2.05}SiO_{4.00}. Deionized water is added according to the ratio of mixture to deionized water 1:3, the material is mixed and ground for 24 hours, then dried in an oven at 120° C., ground with a quartz mortar and filtered through a 40-mesh sieve, and then the powder is put into an alumina crucible and calcined at 1300° C. for 3 hours to obtain the main-phase pre-calcined powder A.

2) Synthesis of auxiliary-phase ceramic material B: The raw materials CaCO₃ and TiO₂ are weighed and mixed according to the chemical composition of CaTiO₃. Deionized water is added according to the ratio of the mixture to deionized water 1:2, the material is mixed and ground for 16 hours and dried in an oven at 120° C., ground with a quartz mortar and filtered through a 40-mesh sieve, and then the powder is put into an alumina crucible and calcined at 1300° C. for 4 hours to obtain auxiliary-phase pre-calcined powder B.

3) 82.4 wt % of the main-phase ceramic material A, 17.3 wt % of the auxiliary-phase ceramic material B, and 0.3 wt % of CeO₂ are mixed. ZrO₂ balls are used as the grinding medium. Deionized water is added according to the weight ratio of mixture: zirconia balls: deionized water 1:5:1.8. After 18 hours of wet mixing, the material is dried at 120° C., and 2 wt % of polyvinyl alcohol (PVA binder) is added for grind and granulating and filtered through a 40-mesh sieve. Then, the granulated powder is pressed into a cylindrical body with a diameter of 20 mm and a height of 10 mm under a pressure of 100 MPa, and the temperature is kept at 1370° C. for 3 hours to obtain a microwave dielectric ceramic of the Comparative Example and its dielectric properties are tested.

Table 1 shows the dielectric properties of the comparative example and embodiments 1 to 9. The dielectric properties are calculated by using Agilent 8719ET network analyser. The Hakki-Coleman resonant cavity method is adopted to test the dielectric constant εᵣ and Q×f values, and the frequency temperature coefficient τ_{f}=(f₈₀−f₂₅)/(f₂₅×55) is calculated and determined accordingly. f₈₀ and f₂₅ are the center frequencies of the sample at 80° C. and 25° C., respectively.

TABLE 1
Microwave dielectric properties of each embodiment

| No. | εᵣ | Q × f (GHz) | τ_{f} (ppm/° C.) |
|---|---|---|---|
| 1 | 9.80 | 63000 | −8 |
| 2 | 10.59 | 58000 | −1.79 |
| 3 | 11.25 | 53500 | 9.6 |
| 4 | 9.50 | 68000 | −16 |
| 5 | 10.48 | 59000 | −1.8 |
| 6 | 10.75 | 55360 | 2.75 |
| 7 | 12.36 | 51090 | 11.6 |
| 8 | 11.98 | 56900 | 4.8 |
| 9 | 13.60 | 45000 | 13 |
| Comparative | 10.30 | 40000 | −2.5 |
| Example 1 | | | |
| Comparative | 10.85 | 49700 | 0.50 |
| Example 2 | | | |

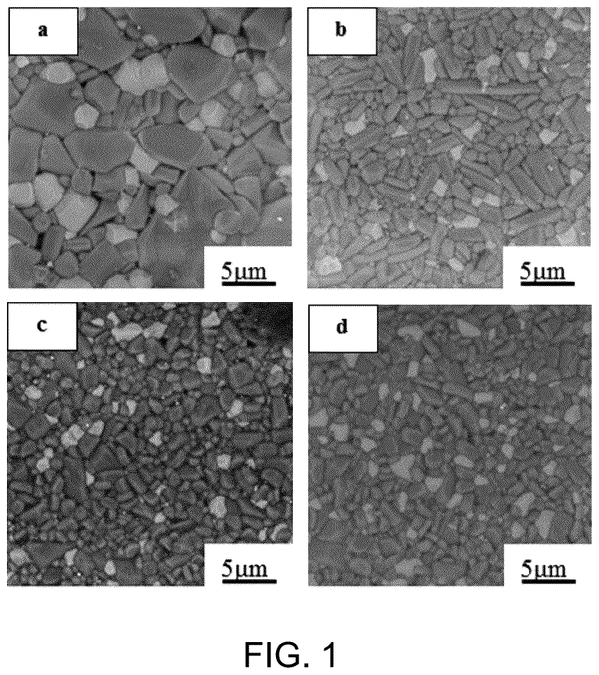

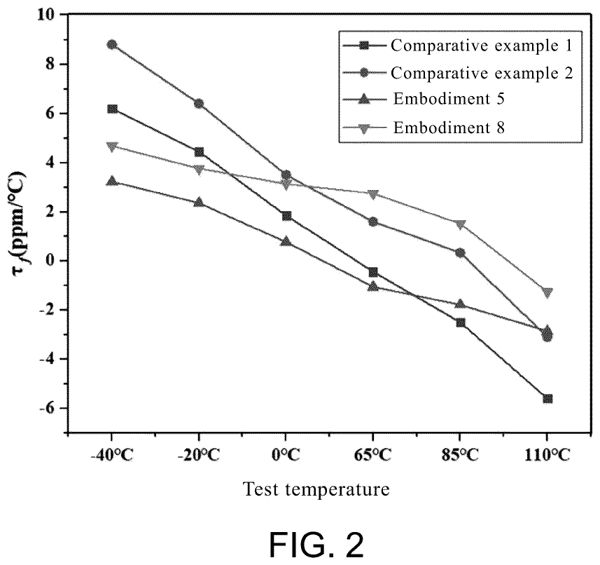

The Q×f values of the embodiments listed in the above table are significantly improved compared with the comparative examples, and the sintering temperature is lower. It can be seen that the materials prepared by the method of the present disclosure have higher Q×f values and the sintering temperature is significantly reduced. In FIG. 1, (a), (b), (c) and (d) are the scanning electron microscope photos of Comparative Example 1, Comparative Example 2, Embodiment 3 and Embodiment 6, respectively. It can be seen that the grain size of the dielectric ceramics prepared by the present disclosure is uniform with good density, and there is no abnormal growth phenomenon. FIG. 2 is a comparison chart of the temperature coefficients of −40° C. to 110° C. in Comparative Example 1, Comparative Example 2, Embodiment 5 and Embodiment 8. With reference to Comparative Example 1 and Comparative Example 2 both, it can be seen that CaTiO₃ has not been modified by doping. In this case, the temperature coefficient of one side (i.e. −40° C. or 110° C.) of the full temperature range can only be adjusted to <±5 ppm/° C. Comparing the comparative example with Embodiments 5 and 8, it can be seen that the modification of the auxiliary-phase ceramic B by the method of the present disclosure can significantly improve the temperature coefficient of the material in the full temperature range to within <±5 ppm/° C.

It should be noted that, in the description of the present disclosure, the terms “comprising”, “including” and the like are intended to cover non-exclusive inclusion, and also include processes, methods and raw materials of other elements not explicitly listed. “An embodiment” or a “specific embodiment” and the like means that a particular feature, structure, material, or feature described in connection with the embodiment is included in at least one embodiment of the present disclosure.

Therefore, although specific embodiments have been used to describe the disclosure above, it should be understood that the above embodiments are used to understand the method and core matters of the present disclosure, and should not be construed as a limitation of the present disclosure. Those skilled in the art can change, modify, replace and modify the above embodiments within the scope of the present disclosure without departing from the principle and purpose of the present disclosure. Any simple modification, equivalent change and modification of the present disclosure shall be regarded as falling with the scope to be protected by the present disclosure.

1. A frequency-stable low-dielectric microwave dielectric ceramic material, consisting of the following components in percentage by mass: 70 to 90% of a main-phase ceramic material A, 10 to 30% of an auxiliary-phase ceramic material B and 0 to 1.0% of an oxide sintering aid C, wherein a sum of mass percentage of the main-phase ceramic material A, the auxiliary-phase ceramic material B and the oxide sintering aid C is 100%; wherein the main-phase ceramic material A satisfies a chemical formula MgₓMe_{y}SiO_{2+x+y}, and Me is Co or Zn, the auxiliary-phase ceramic material B is composed of αRO-bRe₂O₃-cTiO₂, wherein R is at least one of Ca or Sr, and Re₂₀₃ is at least two of Sm₂O₃, Nd₂O₃, Y₂O₃, Al₂O₃ and La₂O₃, and the oxide sintering aid C is at least one of MnO₂, MnCO₃, WO₃, and CeO₂.

2. The frequency-stable low-dielectric microwave dielectric ceramic material according to claim 1, wherein 2.00≤x+y≤2.20, 1.80≤x≤2.15, 0≤y≤0.40.

3. The frequency-stable low-dielectric microwave dielectric ceramic material according to claim 1, wherein 1.0≤a≤2.0, 0.05≤b≤0.50, 1.0≤c≤1.5.

4. The frequency-stable low-dielectric microwave dielectric ceramic material according to claim 1, wherein 2.00≤x+y≤2.10, 1.80≤x≤2.05, 0.05≤y≤0.25.

5. The frequency-stable low-dielectric microwave dielectric ceramic material according to claim 1, wherein 1.0≤a≤1.5, 0.05≤b≤0.30, 1.0≤c≤1.2.

6. The frequency-stable low-dielectric microwave dielectric ceramic material according to claim 1, wherein Re₂O₃ in the chemical formula of the auxiliary-phase ceramic material B is Al₂O₃ and Sm₂O₃, or Al₂O₃ and Nd₂O₃, or Al₂O₃ and Y₂O₃, or Al₂O₃ and La₂O₃.

7. A preparation method for preparing the frequency-stable low-dielectric microwave dielectric ceramic material according to claim 1, comprising the following steps:
step 1) synthesis of the main-phase ceramic material A:
raw materials MgO, SiO₂, ZnO, and CoO are weighed and mixed according to a ratio of the chemical formula MgₓMe_{y}SiO_{2+x+y} to obtain a first mixture, wherein a deionized water is used as a solvent, and the first mixture is ball-milled for 16 to 24 hours and then dried; the dried mixture is filtered through a 40-mesh sieve, put into an alumina crucible, calcined at 1150° C. to 1300° C. for 2 to 4 hours to synthesize a main-phase powder A, the main-phase powder A is ground and filtered through the 40-mesh sieve for use;
step 2) synthesis of the auxiliary-phase ceramic material B:
according to the chemical formula αRO-bRe₂O₃-cTiO₂, raw materials CaCO₃, SrCO₃, Sm₂O₃, Nd₂O₃, Y₂O₃, Al₂O₃ and La₂O₃ are weighed and mixed to obtain a second mixture, wherein the deionized water is used as the solvent, the second mixture is ball-milled for 16 to 24 hours, and then dried, and then filtered through the 40-mesh sieve, loaded into the alumina crucible, calcined at 1100° C. to 1300° C. for 2 to 4 hours to synthesize an auxiliary-phase powder B, which is ground and filtered through the 40-mesh sieve for use;
step 3) the main-phase ceramic material A, the auxiliary-phase ceramic material B and the oxide sintering aid C are prepared according to a certain ratio to obtain a third mixture, ZrO₂ balls are used as a grinding medium, and the deionized water is added according to a weight ratio of the third mixture to the deionized water 1:1.5 to 2, wet mixing is adopted to mix the third mixture and the deionized water for 12 to 18 hours, thn being dried at 120° C., added with 1% to 3% of polyvinyl alcohol binder by weight for grinding and granulating, and filtered through the 40-mesh sieve, under a pressure of 80 to 120 MPa, pressed into a green body with a diameter of 20 mm and a thickness of 10 mm, and sintered at 1300° C. to 1450° C. for 2 to 4 hours in an air atmosphere to obtain the frequency-stable low-dielectric microwave dielectric ceramic material.

8. The frequency-stable low-dielectric microwave dielectric ceramic material according to claim 2, wherein Re₂O₃ in the chemical formula of the auxiliary-phase ceramic material B is Al₂O₃ and Sm₂O₃, or Al₂O₃ and Nd₂O₃, or Al₂O₃ and Y₂O₃, or Al₂O₃ and La₂O₃.

9. The frequency-stable low-dielectric microwave dielectric ceramic material according to claim 3, wherein Re₂O₃ in the chemical formula of the auxiliary-phase ceramic material B is Al₂O₃ and Sm₂O₃, or Al₂O₃ and Nd₂O₃, or Al₂O₃ and Y₂O₃, or Al₂O₃ and La₂O₃.

10. The frequency-stable low-dielectric microwave dielectric ceramic material according to claim 4, wherein Re₂O₃ in the chemical formula of the auxiliary-phase ceramic material B is Al₂O₃ and Sm₂O₃, or Al₂O₃ and Nd₂O₃, or Al₂O₃ and Y₂O₃, or Al₂O₃ and La₂O₃.

11. The frequency-stable low-dielectric microwave dielectric ceramic material according to claim 5, wherein Re₂O₃ in the chemical formula of the auxiliary-phase ceramic material B is Al₂O₃ and Sm₂O₃, or Al₂O₃ and Nd₂O₃, or Al₂O₃ and Y₂O₃, or Al₂O₃ and La₂O₃.

12. A preparation method for preparing the frequency-stable low-dielectric microwave dielectric ceramic material according to claim 2, comprising the following steps:
step 1) synthesis of the main-phase ceramic material A:
raw materials MgO, SiO₂, ZnO, and CoO are weighed and mixed according to a ratio of the chemical formula MgₓMe_{y}SiO_{2+x+y} to obtain a first mixture, wherein a deionized water is used as a solvent, and the first mixture is ball-milled for 16 to 24 hours and then dried; the dried mixture is filtered through a 40-mesh sieve, put into an alumina crucible, calcined at 1150° C. to 1300° C. for 2 to 4 hours to synthesize a main-phase powder A, the main-phase powder A is ground and filtered through the 40-mesh sieve for use;
step 2) synthesis of the auxiliary-phase ceramic material B:
according to the chemical formula αRO-bRe₂O₃-cTiO₂, raw materials CaCO₃, SrCO₃, Sm₂O₃, Nd₂O₃, Y₂O₃, Al₂O₃ and La₂O₃ are weighed and mixed to obtain a second mixture, wherein the deionized water is used as the solvent, the second mixture is ball-milled for 16 to 24 hours, and then dried, and then filtered through the 40-mesh sieve, loaded into the alumina crucible, calcined at 1100° C. to 1300° C. for 2 to 4 hours to synthesize an auxiliary-phase powder B, which is ground and filtered through the 40-mesh sieve for use;
step 3) the main-phase ceramic material A, the auxiliary-phase ceramic material B and the oxide sintering aid C are prepared according to a certain ratio to obtain a third mixture, ZrO₂ balls are used as a grinding medium, and the deionized water is added according to a weight ratio of the third mixture to the deionized water 1:1.5 to 2, wet mixing is adopted to mix the third mixture and the deionized water for 12 to 18 hours, thn being dried at 120° C., added with 1% to 3% of polyvinyl alcohol binder by weight for grinding and granulating, and filtered through the 40-mesh sieve, under a pressure of 80 to 120 MPa, pressed into a green body with a diameter of 20 mm and a thickness of 10 mm, and sintered at 1300° C. to 1450° C. for 2 to 4 hours in an air atmosphere to obtain the frequency-stable low-dielectric microwave dielectric ceramic material.

13. A preparation method for preparing the frequency-stable low-dielectric microwave dielectric ceramic material according to claim 3, comprising the following steps:
step 1) synthesis of the main-phase ceramic material A:
raw materials MgO, SiO₂, ZnO, and CoO are weighed and mixed according to a ratio of the chemical formula MgₓMe_{y}SiO_{2+x+y} to obtain a first mixture, wherein a deionized water is used as a solvent, and the first mixture is ball-milled for 16 to 24 hours and then dried; the dried mixture is filtered through a 40-mesh sieve, put into an alumina crucible, calcined at 1150° C. to 1300° C. for 2 to 4 hours to synthesize a main-phase powder A, the main-phase powder A is ground and filtered through the 40-mesh sieve for use;
step 2) synthesis of the auxiliary-phase ceramic material B:
according to the chemical formula αRO-bRe₂O₃-cTiO₂, raw materials CaCO₃, SrCO₃, Sm₂O₃, Nd₂O₃, Y₂O₃, Al₂O₃ and La₂O₃ are weighed and mixed to obtain a second mixture, wherein the deionized water is used as the solvent, the second mixture is ball-milled for 16 to 24 hours, and then dried, and then filtered through the 40-mesh sieve, loaded into the alumina crucible, calcined at 1100° C. to 1300° C. for 2 to 4 hours to synthesize an auxiliary-phase powder B, which is ground and filtered through the 40-mesh sieve for use;
step 3) the main-phase ceramic material A, the auxiliary-phase ceramic material B and the oxide sintering aid C are prepared according to a certain ratio to obtain a third mixture, ZrO₂ balls are used as a grinding medium, and the deionized water is added according to a weight ratio of the third mixture to the deionized water 1:1.5 to 2, wet mixing is adopted to mix the third mixture and the deionized water for 12 to 18 hours, thn being dried at 120° C., added with 1% to 3% of polyvinyl alcohol binder by weight for grinding and granulating, and filtered through the 40-mesh sieve, under a pressure of 80 to 120 MPa, pressed into a green body with a diameter of 20 mm and a thickness of 10 mm, and sintered at 1300° C. to 1450° C. for 2 to 4 hours in an air atmosphere to obtain the frequency-stable low-dielectric microwave dielectric ceramic material.

14. A preparation method for preparing the frequency-stable low-dielectric microwave dielectric ceramic material according to claim 4, comprising the following steps:
step 1) synthesis of the main-phase ceramic material A:
raw materials MgO, SiO₂, ZnO, and CoO are weighed and mixed according to a ratio of the chemical formula MgₓMe_{y}SiO_{2+x+y} to obtain a first mixture, wherein a deionized water is used as a solvent, and the first mixture is ball-milled for 16 to 24 hours and then dried; the dried mixture is filtered through a 40-mesh sieve, put into an alumina crucible, calcined at 1150° C. to 1300° C. for 2 to 4 hours to synthesize a main-phase powder A, the main-phase powder A is ground and filtered through the 40-mesh sieve for use;
step 2) synthesis of the auxiliary-phase ceramic material B:
according to the chemical formula αRO-bRe₂O₃-cTiO₂, raw materials CaCO₃, SrCO₃, Sm₂O₃, Nd₂O₃, Y₂O₃, Al₂O₃ and La₂O₃ are weighed and mixed to obtain a second mixture, wherein the deionized water is used as the solvent, the second mixture is ball-milled for 16 to 24 hours, and then dried, and then filtered through the 40-mesh sieve, loaded into the alumina crucible, calcined at 1100° C. to 1300° C. for 2 to 4 hours to synthesize an auxiliary-phase powder B, which is ground and filtered through the 40-mesh sieve for use;
step 3) the main-phase ceramic material A, the auxiliary-phase ceramic material B and the oxide sintering aid C are prepared according to a certain ratio to obtain a third mixture, ZrO₂ balls are used as a grinding medium, and the deionized water is added according to a weight ratio of the third mixture to the deionized water 1:1.5 to 2, wet mixing is adopted to mix the third mixture and the deionized water for 12 to 18 hours, thn being dried at 120° C., added with 1% to 3% of polyvinyl alcohol binder by weight for grinding and granulating, and filtered through the 40-mesh sieve, under a pressure of 80 to 120 MPa, pressed into a green body with a diameter of 20 mm and a thickness of 10 mm, and sintered at 1300° C. to 1450° C. for 2 to 4 hours in an air atmosphere to obtain the frequency-stable low-dielectric microwave dielectric ceramic material.

15. A preparation method for preparing the frequency-stable low-dielectric microwave dielectric ceramic material according to claim 5, comprising the following steps:
step 1) synthesis of the main-phase ceramic material A:
raw materials MgO, SiO₂, ZnO, and CoO are weighed and mixed according to a ratio of the chemical formula MgₓMe_{y}SiO_{2+x+y} to obtain a first mixture, wherein a deionized water is used as a solvent, and the first mixture is ball-milled for 16 to 24 hours and then dried; the dried mixture is filtered through a 40-mesh sieve, put into an alumina crucible, calcined at 1150° C. to 1300° C. for 2 to 4 hours to synthesize a main-phase powder A, the main-phase powder A is ground and filtered through the 40-mesh sieve for use;
step 2) synthesis of the auxiliary-phase ceramic material B:
according to the chemical formula αRO-bRe₂O₃-cTiO₂, raw materials CaCO₃, SrCO₃, Sm₂O₃, Nd₂O₃, Y₂O₃, Al₂O₃ and La₂O₃ are weighed and mixed to obtain a second mixture, wherein the deionized water is used as the solvent, the second mixture is ball-milled for 16 to 24 hours, and then dried, and then filtered through the 40-mesh sieve, loaded into the alumina crucible, calcined at 1100° C. to 1300° C. for 2 to 4 hours to synthesize an auxiliary-phase powder B, which is ground and filtered through the 40-mesh sieve for use;
step 3) the main-phase ceramic material A, the auxiliary-phase ceramic material B and the oxide sintering aid C are prepared according to a certain ratio to obtain a third mixture, ZrO₂ balls are used as a grinding medium, and the deionized water is added according to a weight ratio of the third mixture to the deionized water 1:1.5 to 2, wet mixing is adopted to mix the third mixture and the deionized water for 12 to 18 hours, thn being dried at 120° C., added with 1% to 3% of polyvinyl alcohol binder by weight for grinding and granulating, and filtered through the 40-mesh sieve, under a pressure of 80 to 120 MPa, pressed into a green body with a diameter of 20 mm and a thickness of 10 mm, and sintered at 1300° C. to 1450° C. for 2 to 4 hours in an air atmosphere to obtain the frequency-stable low-dielectric microwave dielectric ceramic material.
